(19) United States
(12) Patent Application Publication
(10) Pub. No.: US 2012/0212374 A1
(43) Pub. Date: Aug. 23, 2012

(54) METHOD AND APPARATUS FOR RF-BASED RANGING WITH MULTIPLE ANTENNAS

(75) Inventors: Miles Alexander Lyell Kirby, San Diego, CA (US); David Jonathan Julian, San Diego, CA (US); Rinat Burdo, San Diego, CA (US)

(73) Assignee: QUALCOMM Incorporated, San Diego, CA (US)

(21) Appl. No.: 13/207,063

(22) Filed: Aug. 10, 2011

Related U.S. Application Data
(60) Provisional application No. 61/374,570, filed on Aug. 17, 2010.

(51) Int. Cl. G01S 3/02

(52) U.S. Cl. 342/451; 342/458

(57) ABSTRACT

An apparatus having a first antenna; a second antenna; and a controller coupled to the first and second antennas, wherein the controller is configured to determine a first ranging measurement between the first antenna and a device antenna on a device; determine a second ranging measurement between the second antenna and the device antenna; and determine an orientation and position of the apparatus relative to the device by combining the first and second ranging measurements. A method for implementing the orientation and position process is also disclosed herein.

### CROSS-REFERENCE TO RELATED APPLICATION(S)

This application claims priority to and benefit of U.S. Provisional Application Ser. No. 61/374,570 (Attorney Docket Number 102665P1), entitled “METHOD AND APPARATUS FOR RF-BASED RANGING WITH MULTIPLE ANTENNAS ON A NETWORK NODE,” filed on Aug. 17, 2010, which is expressly incorporated by reference herein in its entirety.

### BACKGROUND

1. Field

The present disclosure relates generally to determining a position and orientation of an apparatus with respect to another device, and more particularly, to an apparatus and methods for radio frequency (RF)-based ranging with multiple antennas.

2. Background

When using interactive media it is important to correctly identify a user's intent expressed, for example, by the user pointing a remote control or a body gesture. In a use example, with Internet browsing on TV, users have to interact with the display at the high accuracy that a PC desk mouse would deliver by pointing a remote control in the air. Video games, such as those used for entertainment or fitness purposes, may become more immersive and enjoyable when user gestures are captured accurately with light-weight wearable accessories in the form of remote controls, wrist/arm band, ring, warrior character armors, hand-held weapon-like accessories, sports gear, etc.

Currently there are approaches based on inertial sensors only, but they do not know the exact orientation to the screen without user input such as orienting the device in a known orientation such as straight at the screen and pushing a button. Similarly there are approaches based on infrared (IR), but they suffer from the IR receivers needing to be in the line of sight of the IR emitter. There is a need in the art for an approach that provides a true relative orientation without human intervention for calibration and with the ability to orient the devices beyond a tight angle directed toward the screen.

RF-based ranging can enable motion capturing or enhance the accuracy of other motion capturing methods such as inertial sensors, visual feature recognition, etc. For example, inertial sensors suffer from drift errors and visual feature recognition fails in situations that lack line of sight and suffer longer processing times. Other motion capture modalities, such as optical markers, require extensive and often expensive setup that is undesirable because it is cost prohibitive to purchase the equipment and because they prefer everything to operate with minimum setup. Many times, the modalities are sensitive to conditions in the operating environment that is obviously less controlled than the environment expected by the modalities in the case of many users.

Ranging accuracy can be improved with more points a system can range between. However, cost of implementation increases with addition of RF nodes. For example, in a case of accurately identifying position and orientation of a remote control pointing at a TV, accuracy of ranging would improve when measuring a distance between the tip of the remote control and four corners of a TV compared to only one point of a TV, which may also be a set-top box or other video/audio devices instead of the TV. Similarly, accuracy would improve if distance to the corners of the TV is measured not only from one point in the remote control but from two points on the remote control. The same concept can be applied with wearable accessories that can send/receive RF signals between them and to fixed antennas off the user's or users' body. Ranging between an arm band and four points on a game console, TV, etc. would deliver better accuracy than ranging between an arm band and only one point on a game console, TV, etc. If ranging is done to more than one point on a game armor that is worn on a leg the resulting accuracy would be better than if ranging was done only to one point on the armor. If the point to which the distance is measured is a node on a wireless network that has its own controller/chip and antenna components, the number of the chip needed for accurate ranging scales quickly.

### SUMMARY

The following presents a simplified summary of one or more aspects of a method and apparatus for RF-based ranging with multiple antennas in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to various aspects, the subject innovation relates to apparatus and methods that provide wireless communications, where apparatus for determining at least one of an orientation or a position relative to a device is provided that includes a first antenna; a second antenna; and a controller coupled to the first and second antennas. The controller is configured to determine a first ranging measurement between the first antenna and a device antenna on a device; determine a second ranging measurement between the second antenna and the device antenna; and determine the at least one of the orientation or the position of the apparatus relative to the device using the first and second ranging measurements.

In another aspect, a method for determining at least one of an orientation or a position of an apparatus relative to a device is provided that includes determining a first ranging measurement between a first antenna of the apparatus and a device antenna of the device using a controller; determining a second ranging measurement between a second antenna of the apparatus and the device antenna of the device using the controller; and determining the at least one of the orientation or the position of the apparatus relative to the device using the first and second ranging measurements using the controller.

In yet another aspect, an apparatus for determining at least one of an orientation or a position of the apparatus relative to a device is provided that includes means for determining a first ranging measurement between a first antenna of the apparatus and a device antenna of the device using a controller; means for determining a second ranging measurement between a second antenna of the apparatus and the device antenna of the device using the controller; and means for determining the at least one of the orientation or the position of the apparatus relative to the device using the first and second ranging measurements using the controller.

In yet another aspect, a computer-program product for wireless communications is provided that includes a machine-readable medium including instructions executable to determine a first ranging measurement between a first antenna of the apparatus and a device antenna of the device using a controller; determine a second ranging measurement between a second antenna of the apparatus and the device antenna of the device using the controller; and determine the at least one of the orientation or the position of the apparatus relative to the device by using the first and second ranging measurements using the controller.

In yet another aspect, a display is provided that includes a screen; a first antenna mounted at a first location on the screen; a second antenna mounted at a second location on the screen; and a controller coupled to the first and second antennas. The controller is configured to determine a first ranging measurement between the first antenna and a device antenna on a device; determine a second ranging measurement between the second antenna and the device antenna; and determine at least one of an orientation or the position of the apparatus relative to the device using the first and second ranging measurements to facilitate motion capture.

In yet another aspect, a remote control is provided that includes a housing; a first antenna mounted at a first location in the housing; a second antenna mounted at a second location in the housing; and a controller coupled to the first and second antennas. The controller is configured to determine a first ranging measurement between the first antenna and a device antenna on a device; determine a second ranging measurement between the second antenna and the device antenna; and determine at least one of an orientation or the position of the apparatus relative to the device using the first and second ranging measurements to facilitate motion capture

To the accomplishment of the foregoing and related ends, the one or more aspects comprise the features hereinafter fully described and particularly pointed out in the claims. The following description and the annexed drawings set forth in detail certain illustrative aspects of the one or more aspects. These aspects are indicative, however, of but a few of the various ways in which the principles of various aspects may be employed and the described aspects are intended to include all such aspects and their equivalents.

### BRIEF DESCRIPTION OF THE DRAWINGS

So that the manner in which the described features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram of an example radio frequency (RF)-based ranging controller configured in accordance with certain aspects of the present disclosure.

FIG. 2 illustrates an example ranging between a remote control with two antennas and a TV with two antennas.

FIG. 3 illustrates an example ranging between a remote control with two antennas and a TV with four antennas.

FIG. 4 illustrates an example ranging between a remote control with one antenna and a TV with four antennas.

FIG. 5 illustrates an example ranging between a remote control with two antennas and a DVD player with two antennas.

FIG. 6 illustrates an example ranging between a remote control with two antennas and a gaming system with two antennas.

FIG. 7 illustrates an example ranging between a remote control with two antennas and a TV with retrofitted antennas.

FIG. 8 illustrates an example ranging between a remote control with two antennas and a game system with additional antennas.

FIG. 9 illustrates an example ranging between a remote control with two antennas and an arm band with additional antennas.

FIG. 10 illustrates an example RF-based ranging operation configured in accordance with certain aspects of the present disclosure.

FIG. 11 is a block diagram illustrating an apparatus for RF-based ranging using multiple antennas with a single chip.

FIG. 12 is a block diagram illustrating an apparatus including means for RF-based ranging using multiple antennas with a single chip.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The number of components, and hence the cost of implementation, may be reduced by having a system that allows one single chip, also referred to as a controller, control multiple antennas that participate in the radio frequency (RF)-based ranging. For example, in a TV, a single chip may be integrated into the TV that can be wired to multiple antennas located in various points on the frame of the TV. The chip can control the timing for each to measure the distance to another node in the network. This other node also includes a chip to which multiple antennas may be coupled. These multiple antennas may be integrated with a single chip in many ways and then the chip can process the combined ranging measurements to a positioning estimate of that node. The positioning estimation may be combined with other motion detection information such as that received from inertial or other sensors in the node.

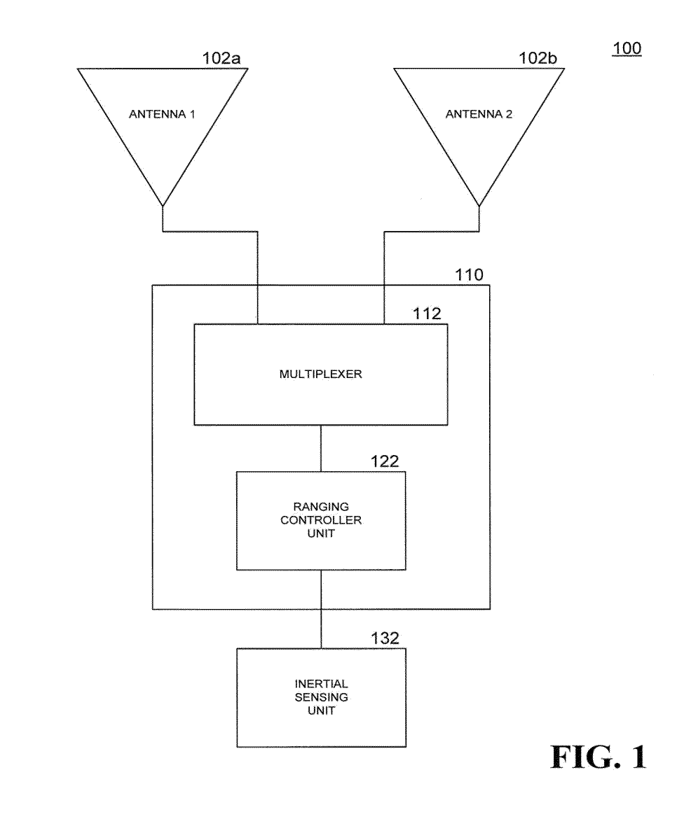

FIG. 1 illustrates an example RF-based ranging controller 100 configured in accordance with certain aspects of the present disclosure. The controller 100 includes multiple antennas 102a, 102b coupled to a ranging module 110 that includes a multiplexer 112 that switches connectivity between the multiple antennas 102a, 102b and a ranging controller unit 122. The controller 100 may be integrated into many different types of devices, as further described below.

The controller 100 also includes an inertial sensing unit 132 coupled to the ranging controller unit 122. The inertial sensing unit 132 may comprise one or more inertial sensors. As discussed herein, inertial sensors as described herein include such sensors as accelerometers, magnetometers, gyros or inertial measurement units (IMU). IMUs are a combination of both accelerometers and gyros. The operation and functioning of these sensors are familiar to those of ordinary skill in the art.

In various aspects of the disclosure set forth herein, ranging is referred to in various implementations. As used herein, ranging is a sensing mechanism that determines the distance between two ranging detection equipped nodes such as two proximity sensors. The ranges may be combined with measurements from other sensors such as inertial sensors to correct for errors and provide the ability to estimate drift components in the inertial sensors. In various aspects of the disclosed approach, inertial sensors may be used in the device and, using the orientation from the multi-antenna ranging, the absolute position of the inertial sensors may be calibrated. Additionally, the inertial sensors may help with the multi-antenna ranging. The inertial sensors could be used to compensate for slight changes in orientation between the successive ranging attempts from the two antennas. The inertial sensors may only give relative changes, but potentially at a faster update rate than the ranging measurements, while the ranging measurements give an absolute orientation in the room/screen frame of reference. In various aspects of the approach, a Kalman filter may be used to combine the ranging measurements and inertial sensor measurements to determine the orientation estimate.

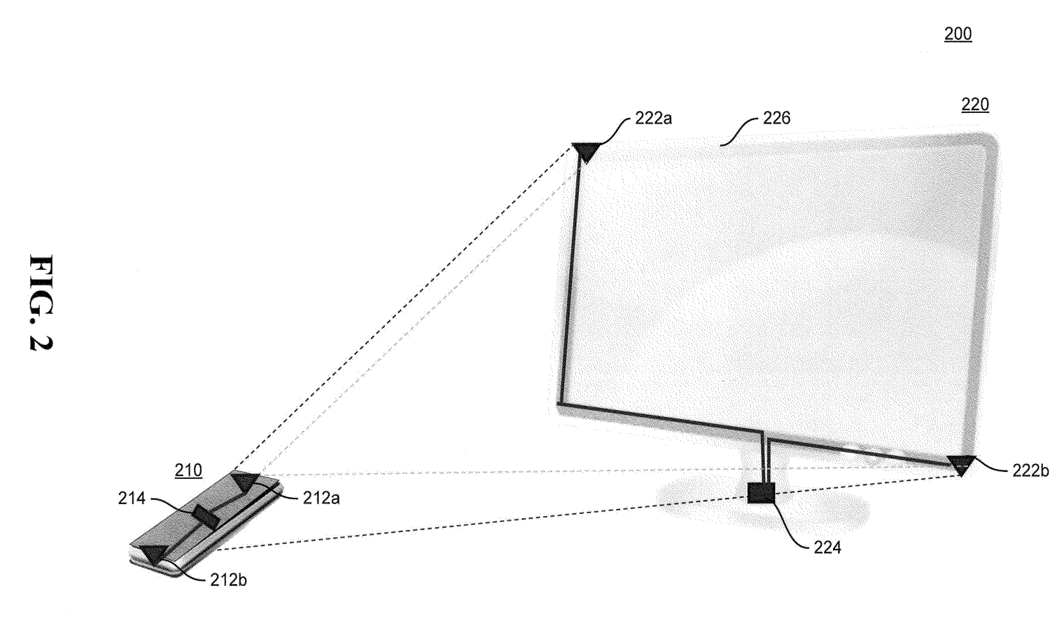

FIG. 2 illustrates an example ranging arrangement 200 between a hand held device such as a remote control 210 with two antennas 212a, 212b and a TV 220 with two antennas 222a, 222b mounted around a screen 226, each with a single controller, or chip 214, 224, respectively, for controlling the ranging measurements using the various antennas. In one aspect of the single controller/multiple antenna configuration as illustrated by FIG. 2, a time duplex approach may be used, where mechanical or electrical switches are used to multiplex a controller such as the chip 214 between antennas 212a, 212b. This may be done either sequentially through each antenna 212a, 212b, or in any particular pattern. In another aspect of the single controller/multiple antenna configuration, multiple RF front ends may be implemented on the same controller. Most of the other functionality on the controller will still be shared.

The single controller/multiple antenna configuration in each of the remote control 210 and the TV 220 of FIG. 2 may be implemented using the RF-based ranging controller 100 of FIG. 1. For example, the two antennas 212a, 212b of the remote control 210 may be implemented using corresponding antennas 102a, 102b of FIG. 1 placed on a housing of the remote control 210. Further, the chip 214 of the remote control 210 may be implemented using the ranging module 110 of FIG. 1. As discussed above, each of the two antennas 212a, 212b may be individually multiplexed to the chip 214 using a switch such as multiplexor 112. Through switching/coupling the antennas to the controller in an alternating fashion, ranging may be performed by using each antenna to communicate with antennas on another device such as the two antennas 222a, 222b on the TV 220.

The controller determining the ranging is aware of the relative locations of the antennas. In one aspect of allowing the controller to be aware of the relative locations, the relative positions of the antennas on the device are pre-set. For example, the remote control 210 includes antennas 212a, 212b on two opposite ends of its case. These antennas 212a, 212b could be wired to the single chip 214 that would control the ranging process between each of them and the antennas on the TV 222a, 222b. This is achievable especially if the antennas, such as antennas 222a, 222b, are integrated into the apparatus, such as the TV 220, and are also part of its specification. Knowing the predetermined locations of each of the pair of antennas, ranging may be determined by the antennas communicating with each other. In another aspect, a calibration step for calibrating the locations of each of the pair of antennas that may be performed with an external device when the system is first installed. The external device would be placed in a predefined location (e.g., 1 meter from center of TV 220), and the calibration would be validated either by the user or via other sensors, such as an infrared sensor. As use herein, the term “TV” may apply to any television, monitor or display technology used to display an image, including a display surface for a projection television or a projector.

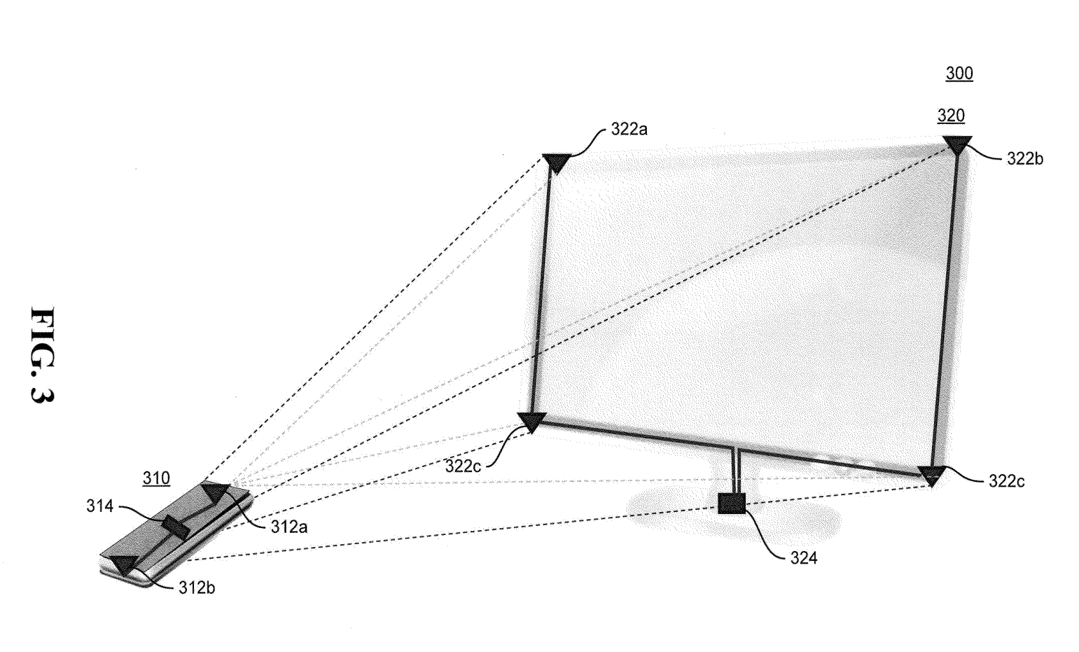

Further, the example ranging arrangement 200 may be used to determine the orientation of the remote 210 to the screen 226. In one aspect of the approach, a distance d1 from antenna 222a to the remote control antenna 212a and a distance d2 from antenna 222a to the remote control antenna 212b may be measured. Additionally a distance d3 from 212a to 212b is known from the manufactured device, or could also be measured using ranging measurements. Then, using the law of cosines, the orientation angle theta from the remote 210 longest axis to the antenna 222a can be computed as theta=arccos[(d3̂2+d1̂2d2̂2)/(2*d1*d3)]. There is still an ambiguity that can be offset by using ranging measurements with antenna 222b to determine the orientation by triangulation for a 2D plane. For 3D space, an additional antenna may be used, such as the configuration illustrated in FIG. 3, below.

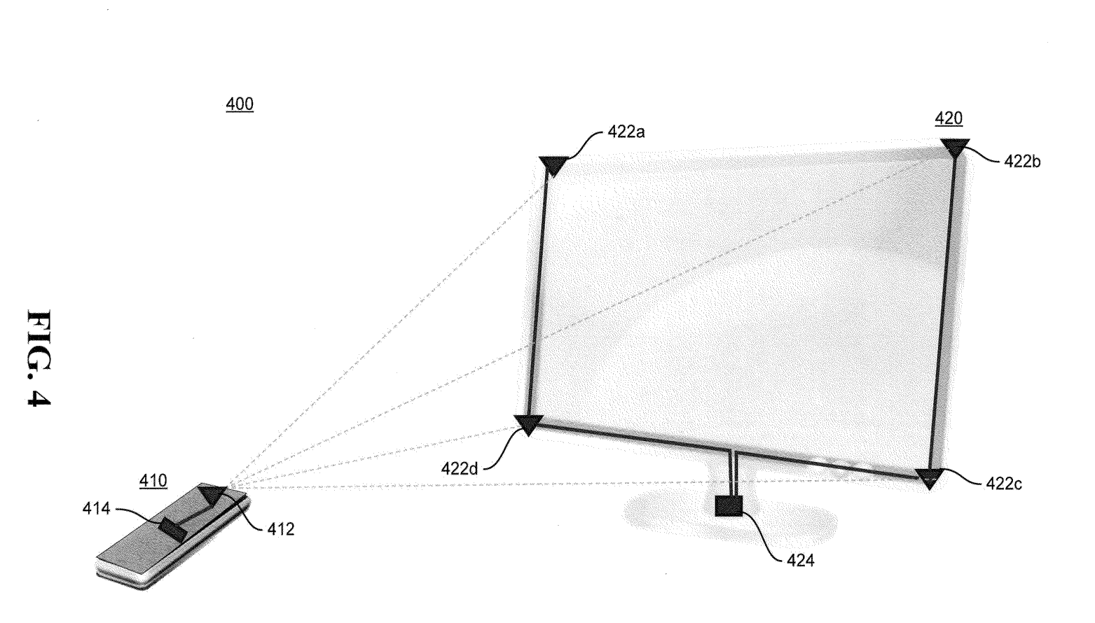

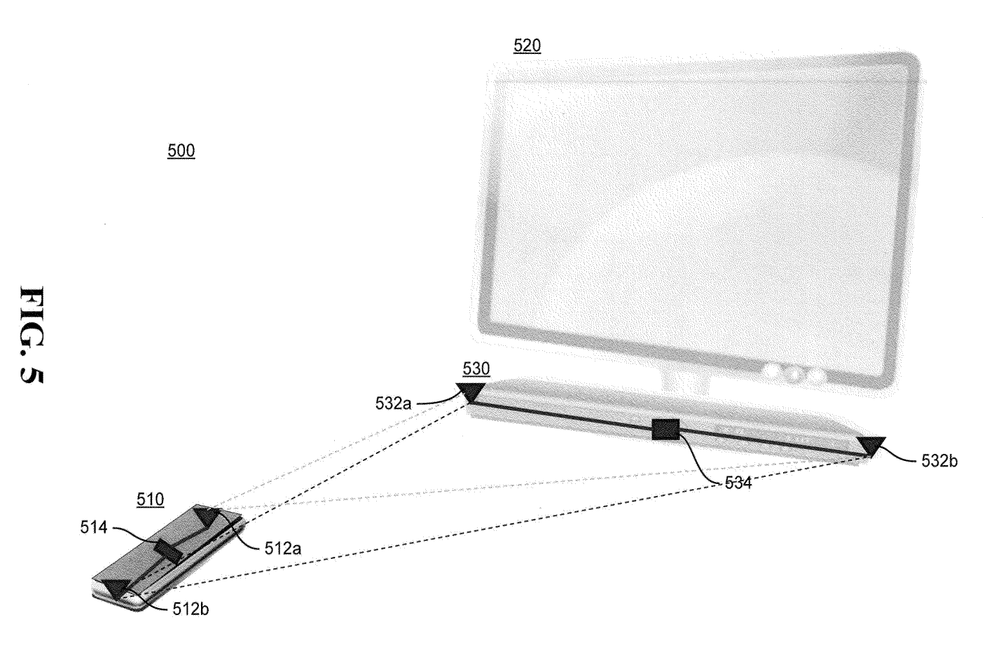

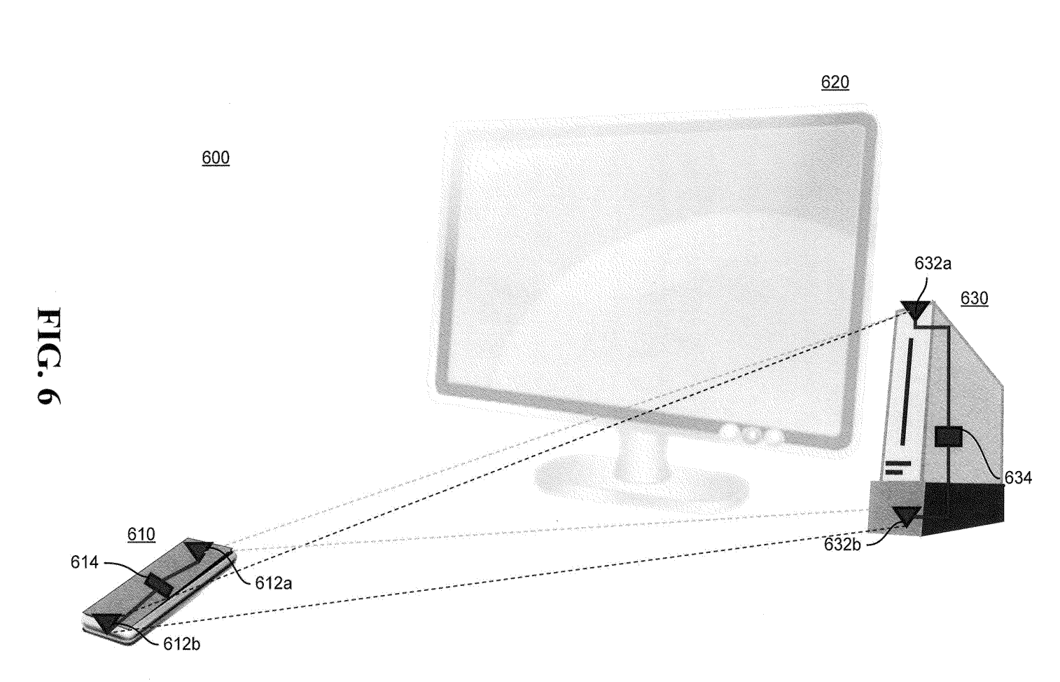

The example shown in FIG. 2 could be applied to other multimedia systems with which ranging would be desired. For example, FIG. 3 illustrates an example ranging arrangement 300 between a remote control 300 with two antennas 312a, 312b and a TV 320 with four antennas 322a-322d, where the extra antennas are useful for refining ranging measurements. FIG. 4 illustrates another example ranging arrangement 400 between a remote control 410 with one antenna 412 coupled to a chip 414, and a TV 420 with four antennas 422a-422d. The four antennas 422a-422d are coupled to a chip 424 as a controller. FIG. 5 illustrates another example ranging arrangement 500 between a remote control 510 with two antennas 512a, 512b and a chip 514, and a DVD player 530 located below a TV 520 with two antennas 532a, 532b and a chip 534. FIG. 6 illustrates another example ranging arrangement 600 between a remote control 610 with two antennas 612a, 612b including a chip 614, and a gaming system 630 with two antennas 632a, 632b coupled to a chip 634.

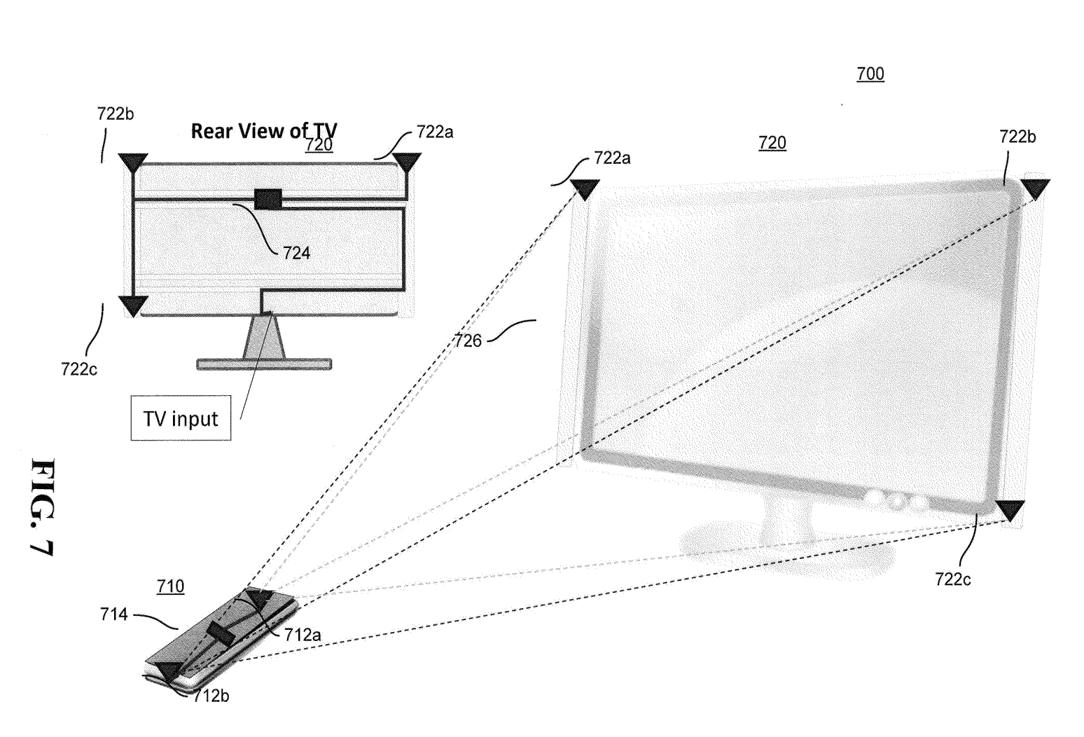

In various aspects, antennas do not have to be integrated into a multimedia system but can be an add-on accessory, such as one or more bars placed next to, on top of, or below a multimedia system. An add-on bar can be attached to a TV similar to the way commercial products such as loud speakers are attached or can be integrated with an add-on accessory that also delivers other functionality. FIG. 7 illustrates an example add-on ranging arrangement 700 between a remote control 710 with two antennas 712a, 712b coupled to a controller chip 714, and a TV 720 outfitted with retrofitted antennas 722a-722c mounted to a frame 726. The retrofitted antennas 722a-722c is coupled to a chip 724.

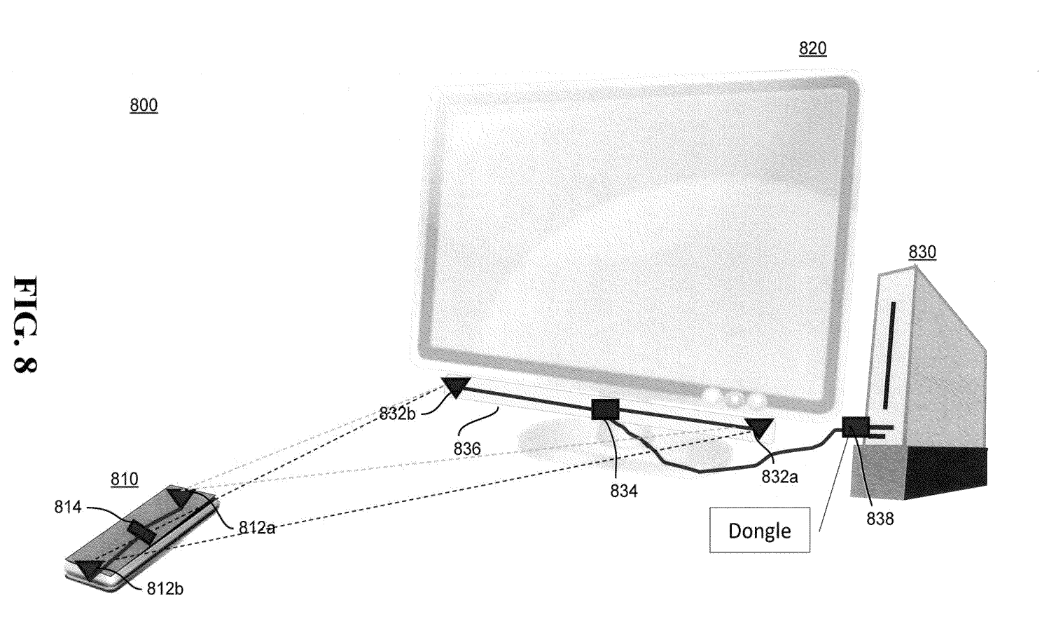

FIG. 8 illustrates another example add-on ranging arrangement 800 between a remote control 810 with two antennas 812a, 812b coupled to a chip 814 and a game system 830 with antennas 832a, 832b coupled to a chip 834. The antennas 832a, 832b and the chip 834 are mounted on a bar 836 that is mounted to a TV 820. The bar 836 is connected to the game system 830 through a dongle 838.

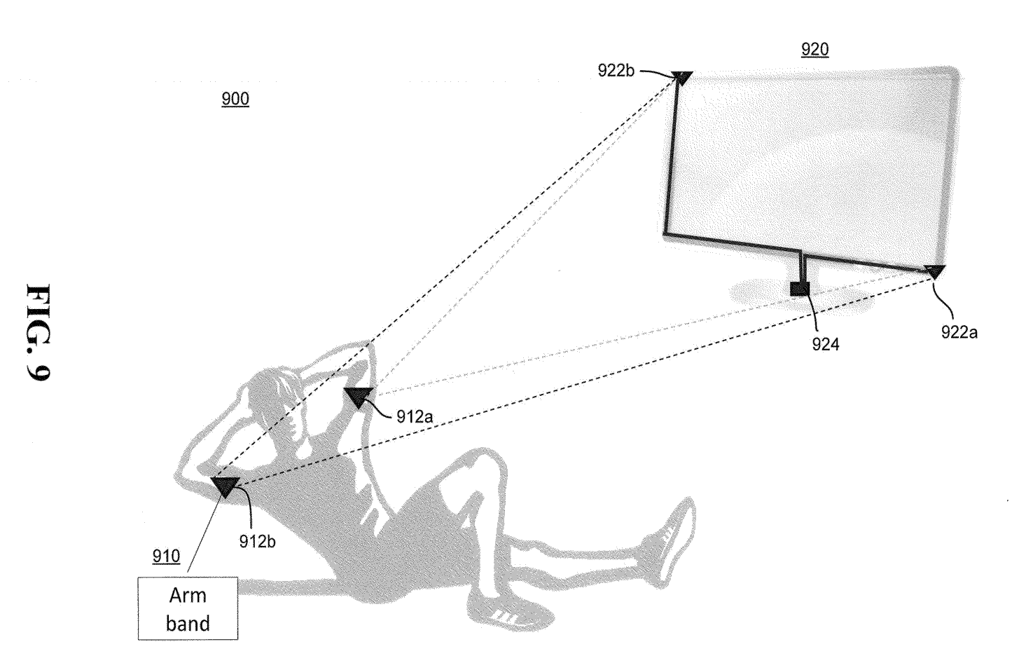

The add-on accessory approach could be applied to another accessory, hand-held or wearable, that can include multiple antennas. For example, FIG. 9 illustrates an example accessory ranging arrangement 900 between an arm band 910 with arm-mounted antennas 912a, 912b and a TV 920 with a pair of integrated antennas 922a, 922b. The antennas 922a, 922b are coupled to a chip 924 for processing the signals.

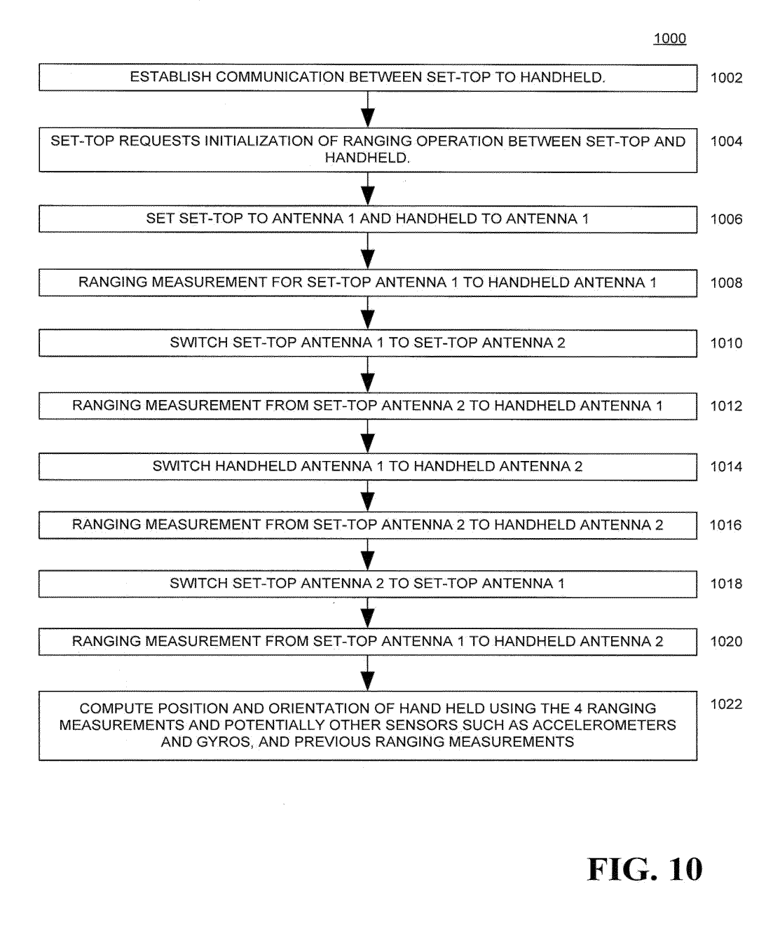

FIG. 10 illustrates a process 1000 for determining the position and orientation of two devices, a handheld device and a set-top device, in accordance with one aspect of the disclosed RF-based ranging system with multiple antennas, where, in step 1002, communication is established between the handheld and the set-top device. The handheld and the set-top device each include a first and a second antenna. Then, in step 1004, the set-top device requests initialization of ranging operations between the handheld and the set-top device. In step 1006, the set-top device is set to communicate over its first antenna and the handheld is also set to communicate over its first antenna. In step 1008, a ranging measurement is made for the first antenna of the set-top device to the first antenna of the handheld. In step 1010, the controller in the set-top device switches from using the first antenna of the set-top device to the second antenna. In step 1012, a ranging measurement is made from the second antenna of the set-top device to the first antenna of the handheld. In step 1014, the controller in the handheld switches from operating on the first antenna of the handheld to the second antenna on the handheld. In step 1016, a ranging measurement is made from the second antenna of the set-top device to the second antenna of the handheld. In step 1018, the set-top controller switches from communicating using the second antenna of the set-top device to the first antenna of the set-top device. In step 1020, a ranging measurement from the first antenna of the set-top device to the second antenna of the handheld is performed. In step 1022, the position and orientation of the handheld may be computed using the four ranging measurements and potentially other sensors such as accelerometers and gyros, and previous ranging measurements.

The position and orientation process may be based on triangulation. It may use additional signal processing algorithms including least squares or point process analysis. Calibration is based on the first and second antennas being placed at defined positions on the apparatus. In various aspects of the disclosure, “defined” could mean predefined or predetermined, or dynamically defined as suited to the system in question. For example, a device such as a TV may have locations set for installing the antennas.

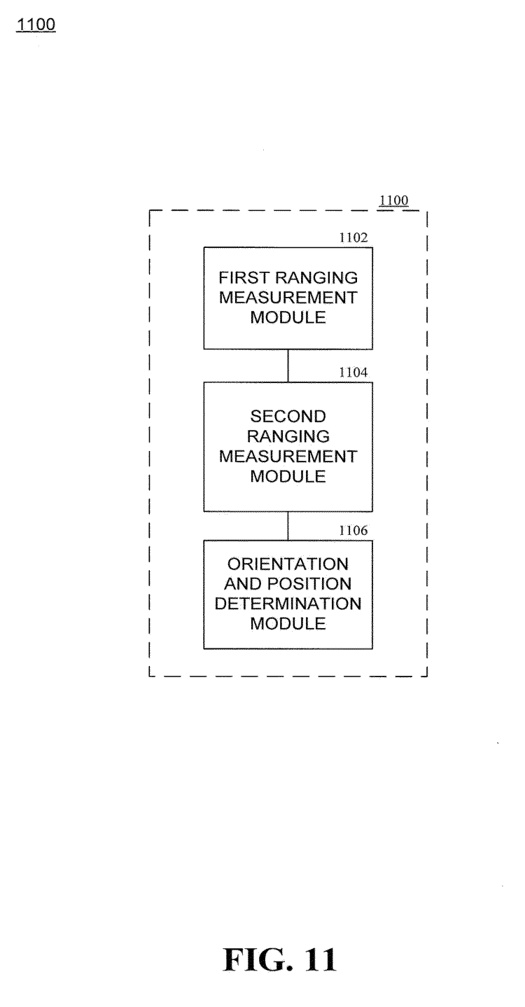

FIG. 11 is a block diagram illustrating an exemplary apparatus 1100 for performing RF-based ranging operations having various modules operable to determine orientation and position of an apparatus relative to a device. As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. A first ranging measurement module 1102 is used for determining a first ranging measurement between a first antenna of the apparatus and a device antenna of the device using a controller. A second ranging measurement module 1104 is configured to determine a second ranging measurement between a second antenna of the apparatus and the device antenna of the device using the controller. An orientation and position determination module 1106 is configured to determine the orientation and position of the apparatus relative to the device by combining the first and second ranging measurements using the controller. In one aspect, a third ranging measurement may be made that is after the first ranging measurement but before the second ranging measurement, where the third ranging measurement may be made from an additional antenna either on the apparatus or the device.

The wireless device may include additional modules that perform each of the steps in the aforementioned flow charts. As such, each step in the aforementioned flow charts may be performed by a module, and the wireless device may include one or more of those modules configured to perform various aspects of the disclosure.

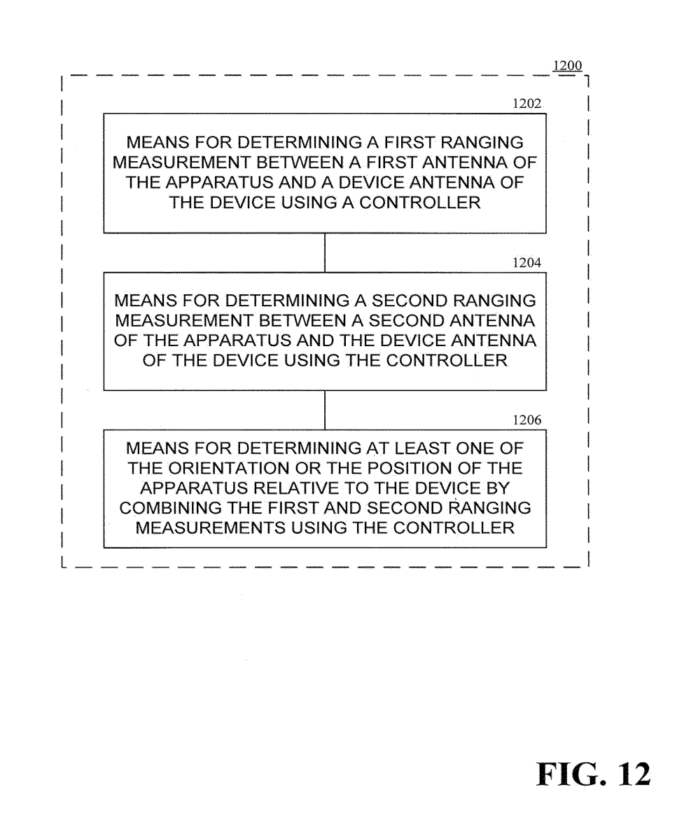

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. Referring to FIG. 12 as an example, in one configuration, an apparatus 1200 for determining at least one of an orientation or a position of an apparatus relative to a device includes a means 1202 for determining a first ranging measurement between a first antenna of the apparatus and a device antenna of the device using a controller. In one configuration, referencing FIG. 2 as an example, the means 1202 for determining the first ranging measurement comprises the chip 214 coupled to the antenna 212a of the remote control 210 and the chip 224 coupled to the antenna 222a. In other configurations, as illustrated by FIGS. 3-9, the means 1202 for determining the first ranging measurement comprises the respective chip and one of the antennas on each device. The apparatus 1200 also includes a means 1204 for determining a second ranging measurement between a second antenna of the apparatus and the device antenna of the device using the controller. In one configuration, the means 1204 for determining the second ranging measurement between the second antenna and the device antenna comprises the antenna 212b coupled to the chip 214 of the remote control 210 and the antenna 222a coupled to the chip 224. In another configuration, the means 1204 for determining the second ranging measurement includes the respective chips and antennas in each of the FIGS. 3-9. The apparatus 1200 further includes a means 1206 for determining the orientation and position of the apparatus relative to the device by combining the first and second ranging measurements using the controller. In one configuration, the means 1206 for determining the orientation and position of the apparatus relative to the device by combining the first and second ranging measurements comprises the chip 214 of the remote control 210. The means 1206 may also comprise the chip 224. In another configuration, the means 1206 for determining the orientation and position of the apparatus relative to the device by combining the first and second ranging measurements comprises the various chips illustrated in each of the FIGS. 3-9.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, a plurality of DSP cores, one or more microprocessors in conjunction with one or more DSP cores, or any other such configuration.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

A wireless device in the present disclosure may include various components that perform functions based on signals that are transmitted by or received at the wireless device. A wireless device may also refer to a wearable wireless device. In some aspects the wearable wireless device may comprise a wireless headset or a wireless watch. For example, a wireless headset may include a transducer adapted to provide audio output based on data received via a receiver. A wireless watch may include a user interface adapted to provide an indication based on data received via a receiver. A wireless sensing device may include a sensor adapted to provide data to be transmitted via a transmitter.

The teachings herein may be incorporated into (e.g., implemented within or performed by) a variety of apparatuses (e.g., devices). For example, one or more aspects taught herein may be incorporated into a television (TV), a remote control, a DVD player, a phone (e.g., a cellular phone), a personal data assistant (“PDA”) or so-called smart phone, an entertainment device (e.g., a portable media device, including music and video players), a headset (e.g., headphones, an earpiece, etc.), a microphone, a medical sensing device (e.g., a biometric sensor, a heart rate monitor, a pedometer, an EKG device, a smart bandage, etc.), a user I/O device (e.g., a watch, a remote control, a light switch, a keyboard, a mouse, etc.), an environment sensing device (e.g., a tire pressure monitor), a monitoring device that may receive data from the medical or environment sensing device (e.g., a desktop, a mobile computer, etc.), a point-of-care device, a hearing aid, a set-top box, or any other suitable device. The monitoring device may also have access to data from different sensing devices via connection with a network.

The previous description is provided to enable any person skilled in the art to fully understand the full scope of the disclosure. Modifications to the various configurations disclosed herein will be readily apparent to those skilled in the art. Thus, the claims are not intended to be limited to the various aspects of the disclosure described herein, but is to be accorded the full scope consistent with the language of claims, wherein reference to an element in the singular is not intended to mean “one and only one” unless specifically so stated, but rather “one or more.” Unless specifically stated otherwise, the term “some” refers to one or more. Also, a claim that recites “at least one of a list of elements refers to one or more of the recited elements. As an example, “at least one of: a, b, or c” is intended to cover: a, b, c, a-b, a-c, b-c, and a-b-c. All structural and functional equivalents to the elements of the various aspects described throughout this disclosure that are known or later come to be known to those of ordinary skill in the art are expressly incorporated herein by reference and are intended to be encompassed by the claims. Thus, it is to be understood that the claims are not limited to the precise configuration and components illustrated above. Various modifications, changes and variations may be made in the arrangement, operation and details of the methods and apparatus described above without departing from the scope of the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An apparatus for determining at least one of an orientation or a position and orientation relative to a device comprising:
a first antenna;
a second antenna; and
a controller coupled to the first and second antennas, wherein the controller is configured to:
determine a first ranging measurement between the first antenna and a device antenna on a device;
determine a second ranging measurement between the second antenna and the device antenna; and
determine the at least one of the orientation or the position of the apparatus relative to the device using the first and second ranging measurements.

2. The apparatus of claim 1, wherein the controller comprises a single radio frequency (RF) device, the controller further configured to:
before determining the first ranging measurement, switch the single RF device to communicate with the first antenna; and
after determining the first ranging measurement, switch the single RF device to communicate with the second antenna.

3. The apparatus of claim 1, wherein the controller comprises a radio frequency (RF) device coupled to each of the first and second antennas, the controller further configured to:
communicate with the device antenna via the RF device for the first antenna; and
communicate with the device antenna via the RF device for the second antenna.

4. The apparatus of claim 1, further comprising a third antenna, wherein the controller is further configured to determine a third ranging measurement between the third antenna and the device antenna, and wherein the first, second and third ranging measurements are used to determine the at least one of the orientation or the position.

5. The apparatus of claim 1, wherein the controller is further configured to:
determine a third ranging measurement between the first antenna and a second device antenna on the device; and
determine a fourth ranging measurement between the second antenna and the second device antenna;
wherein the orientation and position determination of the apparatus relative to the device uses the first, second, third and fourth ranging measurements.

6. The apparatus of claim 5, wherein the determination of the third ranging measurement occurs after the determination of the first ranging measurement and before the determination of the second ranging measurement.

7. The apparatus of claim 1, wherein the controller is further configured to calibrate positions of the first and second antennas.

8. The apparatus of claim 7, wherein the calibration is based on the first and second antennas being placed at various positions on the apparatus.

9. The apparatus of claim 7, wherein the calibration is based on calibration validation information received from an external device.

10. The apparatus of claim 1, wherein the controller is further configured to refine the determination of the orientation and position of the apparatus relative to the device by using the first and second ranging measurements with other motion detection information.

11. The apparatus of claim 1, further comprising an inertial sensing unit coupled to the controller, wherein the controller is further configured to calibrate the inertial sensing unit using an orientation.

12. The apparatus of claim 1, further comprising an inertial sensing unit coupled to the controller, wherein the controller is further configured to:
determine a change in orientation of the inertial sensing unit; and
adjust the at least one of the orientation or the position of the apparatus using the change in orientation of the inertial sensing unit.

13. A method for determining at least one of an orientation or a position and orientation of an apparatus relative to a device comprising:
determining a first ranging measurement between a first antenna of the apparatus and a device antenna of the device using a controller;
determining a second ranging measurement between a second antenna of the apparatus and the device antenna of the device using the controller; and
determining the at least one of the orientation or the position of the apparatus relative to the device using the first and second ranging measurements using the controller.

14. The method of claim 13, wherein the controller comprises a single radio frequency (RF) device, the method further comprising:
before determining the first ranging measurement, switching the single RF device to communicate with the first antenna; and
after determining the first ranging measurement, switching the single RF device to communicate with the second antenna.

15. The method of claim 13, wherein the controller comprises a radio frequency (RF) device coupled to each of the first and second antennas, the method further comprising:
communicating with the device antenna via the RF device for the first antenna; and
communicating with the device antenna via the RF device for the second antenna.

16. The method of claim 13, further comprising:
determining a third ranging measurement between a third antenna of the apparatus and the device antenna using the controller;
wherein the determination of the at least one of the orientation or the position of the apparatus relative to the device further comprises using the first, second and third ranging measurements.

17. The method of claim 13, further comprising:
determining a third ranging measurement between the first antenna and a second device antenna using the controller; and
determining a fourth ranging measurement between the second antenna and the second device antenna using the controller;
wherein the orientation and position determination of the apparatus relative to the device further comprises combining the first, second, third and fourth ranging measurements.

18. The method of claim 17, wherein the determination of the third ranging measurement occurs after the determination of the first ranging measurement and before the determination of the second ranging measurement.

19. The method of claim 13, further comprising calibrating positions of the first and second antennas.

20. The method of claim 19, wherein the calibration comprises placing the first and second antennas at various positions on the apparatus.

21. The method of claim 19, further comprising receiving calibration validation information from an external device.

22. The method of claim 13, further comprising refining the determination of the orientation and position of the apparatus relative to the device by combining the first and second ranging measurements with other motion detection information.

23. The method of claim 13, further comprising calibrating an absolute position of an inertial sensing unit using an orientation of the first and second antennas.

24. The method of claim 13, further comprising :
determining a change in orientation of an inertial sensing unit; and
adjusting the at least one of the orientation or the position of the apparatus using the change in orientation of the inertial sensing unit.

25. An apparatus for determining at least one of an orientation or a position and orientation of the apparatus relative to a device comprising:
means for determining a first ranging measurement between a first antenna of the apparatus and a device antenna of the device using a controller;
means for determining a second ranging measurement between a second antenna of the apparatus and the device antenna of the device using the controller; and
means for determining the at least one of the orientation or the position of the apparatus relative to the device using the first and second ranging measurements using the controller.

26. The apparatus of claim 25, wherein the controller comprises a single radio frequency (RF) device, the apparatus further comprising:
means for switching the single RF device to communicate with the first antenna before determining the first ranging measurement; and
means for switching the single RF device to communicate with the second antenna after determining the first ranging measurement.

27. The apparatus of claim 25, wherein the controller comprises a radio frequency (RF) device coupled to each of the first and second antennas, the apparatus further comprising:
means for communicating with the device antenna via the RF device for the first antenna; and
means for communicating with the device antenna via the RF device for the second antenna.

28. The apparatus of claim 25, further comprising:
means for determining a third ranging measurement between a third antenna of the apparatus and the device antenna using the controller;
wherein the means for determining at least one of the orientation or the position of the apparatus relative to the device further comprises means for using the first, second and third ranging measurements.

29. The apparatus of claim 25, further comprising:
means for determining a third ranging measurement between the first antenna and a second device antenna using the controller; and
means for determining a fourth ranging measurement between the second antenna and the second device antenna using the controller;
wherein the means for determining the at least one of the orientation or the position of the apparatus relative to the device further comprises means for using the first, second, third and fourth ranging measurements.

30. The apparatus of claim 29, wherein the means for determining the third ranging measurement occurs after the determination of the first ranging measurement and before the determination of the second ranging measurement.

31. The apparatus of claim 25, further comprising means for calibrating positions of the first and second antennas.

32. The apparatus of claim 31, wherein the first and second antennas are placed at various positions on the apparatus.

33. The apparatus of claim 31, further comprising means for receiving calibration validation information from an external device.

34. The apparatus of claim 25, further comprising means for refining the determination of the at least one of the orientation or the position of the apparatus relative to the device by using the first and second ranging measurements with other motion detection information.

35. The apparatus of claim 29, further comprising means for calibrating an absolute position of an inertial sensing unit using an orientation of the first and second antennas.

36. The apparatus of claim 29, further comprising :
means for determining a change in orientation of an inertial sensing unit; and
means for adjusting the at least one of the orientation or the position of the apparatus using the change in orientation of the inertial sensing unit.

37. A computer-program product for determining at least one of an orientation and a position and orientation of an apparatus relative to a device, comprising a computer-readable medium comprising instructions executable to:
determine a first ranging measurement between a first antenna of the apparatus and a device antenna of the device using a controller;
determine a second ranging measurement between a second antenna of the apparatus and the device antenna of the device using the controller; and
determine the at least one of the orientation or the position of the apparatus relative to the device by using the first and second ranging measurements using the controller.

38. A display comprising:
a screen;
a first antenna mounted at a first location on the screen;
a second antenna mounted at a second location on the screen; and
a controller coupled to the first and second antennas, wherein the controller is configured to:
determine a first ranging measurement between the first antenna and a device antenna on a device;
determine a second ranging measurement between the second antenna and the device antenna; and
determine at least one of an orientation or a position and orientation of the apparatus relative to the device using the first and second ranging measurements to facilitate motion capture.

39. A remote control comprising:
a housing;
a first antenna mounted at a first location in the housing;
a second antenna mounted at a second location in the housing; and
a controller coupled to the first and second antennas, wherein the controller is configured to:
determine a first ranging measurement between the first antenna and a device antenna on a device;
determine a second ranging measurement between the second antenna and the device antenna; and
determine at least one of an orientation or a position and orientation of the apparatus relative to the device using the first and second ranging measurements to facilitate motion capture.
